(19) United States
(12) Patent Application Publication
(10) Pub. No.: US 2017/0166473 A1
(43) Pub. Date: Jun. 15, 2017

(54) GLASS FOR ANTI-DAZZLE PROCESSING AND ANTI-DAZZLE GLASS USING SAME

(71) Applicant: Asahi Glass Company, Limited, Chiyoda-ku (JP)

(72) Inventors: Junko MIYASAKA, Tokyo (JP); Seiki OHARA, Tokyo (JP)

(73) Assignee: Asahi Glass Company, Limited, Chiyoda-ku (JP)

(21) Appl. No.: 15/390,939

(22) Filed: Dec. 27, 2016

Related U.S. Application Data
(63) Continuation of application No. PCT/JP2015/070202, filed on Jul. 14, 2015.

(30) Foreign Application Priority Data
Jul. 18, 2014 (JP) 2014-148033

(51) Int. Cl. C03C 3/087; C03C 15/00; C03C 21/00

(52) U.S. Cl. CPC C03C 3/087; C03C 21/002; C03C 15/00

(57) ABSTRACT

Provided are a glass for anti-dazzle processing which has low dependency on the concentration of the processing liquid in carrying out the anti-dazzle processing, and an anti-dazzle glass using the same. A glass for anti-dazzle processing contains, as expressed by mass percentage on the basis of oxides, 60 to 75% of SiO₂, 2.5 to 10% of A1₂O₃, 13 to 19% of Na₂O, 0 to 1.8% of K₂O, 0 to 12% of MgO, 0 to 9% of CaO, and 0 to 4% of ZrO₂.

### TECHNICAL FIELD

The present invention relates to a glass suitable for anti-dazzle processing, such as frost processing or antiglare processing which uses a processing liquid containing hydrofluoric acid (HF) and ammonium fluoride (NH₄F). In addition, the present invention relates to an anti-dazzle glass, such as a frost-processed glass or an antiglare-processed glass using the above-described glass.

### BACKGROUND ART

For example, a display device equipped with a display means such as a liquid crystal member or an LED member has been widely used as a small-sized and/or mobile display device such as an electronic notebook, a notebook-type personal computer, a tablet PC, and a smart phone. In such a display device, a cover glass is mounted on the surface for protecting the display device.

With a recent increase in definition of display devices, the cover glass is required to have high visibility for displayed images so as not to impair such a function of highly increased definition. For improving the visibility for the displayed images, it is considered to perform an anti-dazzle processing on the cover glass.

As the anti-dazzle processing on the cover glass that may be subjected to chemical strengthening processing in some cases for enhancing strength, it is preferred to use chemical anti-dazzle processing. The chemical anti-dazzle processing is a processing of exhibiting an anti-dazzle action by forming fine unevenness on a glass surface by using a processing liquid containing hydrofluoric acid and thus enhancing light diffusibility, and is classified into frost processing and antiglare processing depending on height of a haze value that is an index of the light diffusibility (see Non-Patent Document 1).

The frost processing is characterized in that the haze value that is an index of the light diffusibility is high. On the other hand, the antiglare processing, also called as non-glare processing, exhibits an anti-dazzle action by imparting the light diffusibility with keeping resolution as high as possible. Therefore, as indices of the antiglare processing, the haze value that is an index of the light diffusibility and a gloss value that is an index of glossiness are used in combination.

### PRIOR ART DOCUMENTS

### Non-Patent Document

Non-Patent Document 1: Chemical Treatment by Hydrofluoric Acid of Glass Surface, Tatsuya Hosaka and Norio Kikuchi, Journal of the Surface Finishing Society of Japan, Vol. 44, No. 3, 1993, p. 205-208

### SUMMARY OF THE INVENTION

### Problems that the Invention is to Solve

As the processing liquid for use in the anti-dazzle processing, a processing liquid containing hydrofluoric acid (HF) and ammonium fluoride (NH₄F) is preferably used. In the case of a soda lime silicate glass that is hitherto generally known, for enhancing precipitation ability of crystals, it is necessary to use a three-component processing liquid containing potassium fluoride (KF), for example, in addition to the above-described two components.

Moreover, the progress of the anti-dazzle processing is greatly influenced by the concentration of hydrofluoric acid (HF) and ammonium fluoride (NH₄F), particularly the concentration of hydrofluoric acid (HF) in the processing liquid. As a result, for example, in the case of the antiglare processing, there is a case where intended haze value and gloss value cannot be achieved. Since there is such an influence of the dependency on the concentration of the processing liquid in carrying out the anti-dazzle processing, it is necessary to control the concentration of hydrofluoric acid (HF) and ammonium fluoride (NH₄F) in the processing liquid strictly.

In order to solve the above-described problems of a conventional technique, an object of the present invention is to provide a glass for anti-dazzle processing which has low dependency on the concentration of the processing liquid for the gloss value and the haze value in carrying out the anti-dazzle processing, and an anti-dazzle glass using the same.

### Means for Solving the Problems

The present invention is as follows.

1. A glass for anti-dazzle processing, containing, as expressed by mass percentage on the basis of oxides:
60 to 75% of SiO₂,
2.5 to 10% of Al₂O₃,
13 to 19% of Na₂O,
0 to 1.8% of K₂O,
0 to 12% of MgO,
0 to 9% of CaO, and 0 to 4% of ZrO₂.

2. The glass for anti-dazzle processing according to the above item 1, further containing Fe₂O₃ and containing, as expressed by mass percentage on the basis of oxides:
64 to 71% of SiO₂,
2.5 to 10% of Al₂O₃,
13 to 18% of Na₂O,
0 to 1.8% of K₂O,
6 to 12% of MgO,
0.5 to 9% of CaO,
0 to 3% of ZrO₂, and
0 to 0.05% of Fe₂O₃.

3. The glass for anti-dazzle processing according to the above item 1 or 2, in which, in an Na concentration distribution in a sheet thickness direction in at least one main surface of the glass for anti-dazzle processing, an Na concentration at a depth of 0 to 5 nm is lower than an average Na concentration for a depth of 100 to 150 nm, and a depth at which an Na concentration reaches 90% or more of the average Na concentration for the depth of 100 to 150 nm is 10 nm or more.

4. An anti-dazzle glass, in which at least one main surface of the glass for anti-dazzle processing according to any one of the above items 1 to 3 has been subjected to an anti-dazzle processing.

5. The anti-dazzle glass according to the above item 4, in which the anti-dazzle processing is a frost processing.

6. The anti-dazzle glass according to the above item 4, in which the anti-dazzle processing is an antiglare processing.

7. The anti-dazzle glass according to any one of the above items 4 to 6, in which a gloss value is 10 to 90% and a haze value is 4 to 70%, both values being measured for the main surface which has been subjected to the anti-dazzle processing.

8. The anti-dazzle glass according to any one of the above items 4 to 7, in which at least one main surface thereof has been subjected to a chemical strengthening processing.

9. The anti-dazzle glass according to any one of the above items 4 to 8, in which the anti-dazzle processing is a chemical anti-dazzle processing.

### Advantage of the Invention

The glass for anti-dazzle processing of the present invention can be subjected to anti-dazzle processing with a processing liquid containing only two components of hydrofluoric acid (HF) and ammonium fluoride (NH₄F). In addition, in carrying out the anti-dazzle processing, since dependency on concentration of the processing liquid is low for anti-dazzle performance to be obtained (gloss value and haze value), it is not necessary to control the concentration of hydrofluoric acid (HF) and ammonium fluoride (NH₄F) in the processing liquid strictly. Therefore, the anti-dazzle processing is facilitated and the productivity of an anti-dazzle glass is improved.

### BRIEF DESCRIPTION OF THE DRAWINGS

FIG. 1 is a graph showing a relationship between HF concentration in an anti-dazzle processing liquid and a gloss value (%) of a glass after processing in Example 1 and Comparative Example 1.

FIG. 2 is a graph showing a relationship between HF concentration in an anti-dazzle processing liquid and a haze value (%) of a glass after processing in Example 1 and Comparative Example 1.

FIG. 3 shows results of Na concentration distribution normalized by average Na concentration for the depth of 100 to 150 nm.

### MODES FOR CARRYING OUT THE INVENTION

The following will describe the glass for chemical anti-dazzle processing and the anti-dazzle glass of the present invention.

There are described compositional ranges of respective components of the glass for anti-dazzle processing of the present invention. In the present Description, the contents of the glass components are described in terms of mass percentage unless otherwise noted.

SiO₂ is known as a component that forms a network structure in a glass microstructure and is a main component that constitutes the glass.

The content of SiO₂ is 60% or more, preferably 62% or more, and more preferably 64% or more. Moreover, the content of SiO₂ is 75% or less, preferably 73% or less, and more preferably 71% or less. When the content of SiO₂ is 60% or more, it is advantageous in view of weather resistance and stability as the glass. On the other hand, when the content of SiO₂ is 75% or less, it is advantageous in view of meltability and formability.

Al₂O₃ is a component that improves weather resistance of the glass. In addition, in the case where the anti-dazzle glass is further subjected to chemical strengthening processing, it has an action of improving ion-exchangeability and, particularly, it has a large action of improving a surface compression stress (CS).

The content of Al₂O₃ is 2.5% or more, preferably 3% or more, and more preferably 4% or more. Moreover, the content of Al₂O₃ is 10% or less, preferably 9% or less, and more preferably 8% or less.

When the content of Al₂O₃ is 2.5% or more, the dependency on the concentration of the processing liquid for the anti-dazzle performance decreases and stable anti-dazzle performance is obtained. In addition, when the content of Al₂O₃ is 3% or more, in the case where the anti-dazzle glass is further subjected to chemical strengthening processing, a desired surface compression stress (CS) value is obtained through ion exchange, and, at the time of float forming, there can be exhibited an effect of suppressing invasion of tin from the bottom surface and, at the time of chemical strengthening processing of the bottom surface side that has been in contact with tin, a decrease in the surface compression stress (CS) can be prevented.

On the other hand, when the content of Al₂O₃ is 10% or less, the meltability at a high temperature becomes satisfactory and elevation of a temperature T₂ at which a glass viscosity reaches 10² dPa·s can be prevented.

Na₂O is an essential component that lowers high-temperature viscosity and devitrification temperature of the glass, and improves the meltability and formability of the glass. In the case where the anti-dazzle glass is further subjected to chemical strengthening processing, it is a component that forms a chemical strengthening-processed layer through ion exchange.

The content of Na₂O is 13% or more, preferably 14% or more, and more preferably 15% or more. Moreover, the content of Na₂O is 19% or less, preferably 18% or less, and more preferably 17% or less.

When the content of Na₂O is 13% or more, in the case where the anti-dazzle glass is further subjected to chemical strengthening processing, a desired chemical strengthening-processed layer can be formed through ion exchange and the surface compression stress (CS) is improved.

On the other hand, when the content of Na₂O is 19% or less, sufficient weather resistance is obtained and, in the case where the anti-dazzle glass is further subjected to chemical strengthening processing, it is possible to make the glass after chemical strengthening processing hardly warp.

Since K₂O has an effect of increasing an ion-exchanging rate and thickening the chemical strengthening-processed layer in the case where the anti-dazzle glass is further subjected to chemical strengthening processing, it may be contained within a range of 1.8% or less. When the content of K₂O is 1.8% or less, the dependency on the concentration of the processing liquid for the anti-dazzle performance decreases and stable anti-dazzle performance is obtained. In the case of containing K₂O, it is preferably 1.5% or less, more preferably 1.3% or less, and further preferably 1.0% or less.

Since MgO is a component that stabilizes the glass, it may be contained within a range of 12% or less. When it is 12% or less, a property that devitrification hardly occurs is maintained and, in the case where the anti-dazzle glass is further subjected to chemical strengthening processing, a sufficient ion-exchanging rate is obtained. The content of MgO is preferably 10% or less and more preferably 9% or less.

In the case of containing MgO, the content thereof is preferably 2% or more, more preferably 4% or more, further preferably 5% or more, and most preferably 6% or more. When the content of MgO is 2% or more, the meltability at a high temperature becomes satisfactory and elevation of the temperature T₂ at which the glass viscosity reaches 10² dPa·s can be prevented.

In addition, in the case where the anti-dazzle glass is further subjected to chemical strengthening processing, when the MgO is 5% or more, a sufficient ion-exchanging rate is obtained and a chemically strengthening-processed layer having desired thickness is obtained. It is more preferably 6% or more and further preferably 7% or more.

Since CaO is a component that stabilizes the glass, it may be contained within a range of 9% or less. When it is 9% or less, in the case where the anti-dazzle glass is further subjected to chemical strengthening processing, a sufficient ion-exchanging rate is obtained and a chemically strengthening-processed layer having a desired thickness is obtained. The content of CaO is preferably 8% or less, more preferably 7% or less, and further preferably 5% or less.

In the case of containing CaO, the content thereof is preferably 0.1% or more, more preferably 0.3% or more, further preferably 0.5% or more, and still further preferably 1% or more. Moreover, when the content of CaO is 0.1% or more, the meltability at a high temperature becomes satisfactory and devitrification hardly occurs.

ZrO₂ is generally known to have an action of increasing the surface compression stress (CS) in chemical strengthening processing. It may be contained within a range of 4% or less in the case where the anti-dazzle glass is further subjected to chemical strengthening processing. The content of ZrO₂ is preferably 3% or less and more preferably 2% or less. When it is 4% or less, it is possible to prevent an elevation of the devitrification temperature.

The glass for chemical anti-dazzle processing of the present invention essentially consists of the components described above, but may contain other components in such a range that the objects of the present invention are not impaired. As the other components, for example, the following may be mentioned.

B₂O₃ is not an essential component but may be contained within a range of 2% or less since the meltability at a high temperature becomes satisfactory and it has an effect of preventing elevation of the temperature T₂ at which the glass viscosity reaches 10² dPa·s. In order to obtain the above effect, the content of B₂O₃ is preferably 0.5% or more and more preferably 1% or more. In the case where it is intended to make compositional change through evaporation of alkali borate compounds during melting hardly occur, the content of B₂O₃ is preferably 1% or less and more preferably 0.5% or less.

Fe₂O₃ is not an essential component but, since it is present all over the natural world and production lines, it is a component whose content is extremely difficult to reduce to zero. It is known that Fe₂O₃ in an oxidized state becomes a yellow-coloring cause and FeO in a reduced state becomes a blue-coloring cause and it is known that glass is colored green in a balance between the both.

When the content of Fe₂O₃ is 0.5% or less, at the time of use as a cover glass after chemical strengthening processing, the color of a member to be disposed under the cover glass does not change even when observed through the cover glass. The content of Fe₂O₃ is preferably 0.1% or less and more preferably 0.05% or less.

Other than the above, the glass for chemical anti-dazzle processing of the present invention may contain, for example, coloring components such as Co, Cr and Mn, and Zn, Sr, Ba, Ti, Cl, F, and SO₃ in an amount of 3% or less in total, within such a range that the objects of the present invention are not impaired.

The following will describe properties of the glass for chemical anti-dazzle processing of the present invention.

In the glass for chemical anti-dazzle processing of the present invention, since the meltability at a high temperature is satisfactory, the temperature T₂ at which the glass viscosity reaches 10² dPa·s is preferably 1,600° C. or lower. The glass for chemical anti-dazzle processing of the present invention has a temperature T₂ of preferably 1,570° C. or lower, more preferably 1,550° C. or lower. The temperature T₂ can be measured by using a rotary viscometer or the like.

The glass for anti-dazzle processing of the present invention has preferably a glass transition point (Tg) of 520° C. or higher. When Tg is 520° C. or higher, in the case where the anti-dazzle glass is further subjected to chemical strengthening processing, it is advantageous in view of suppression of stress relaxation, suppression of thermal warp, and the like at the time of performing chemical strengthening processing. For example, since the stress relaxation at the time of chemical strengthening processing is suppressed, a high surface compression stress (CS) can be obtained: Tg is more preferably 540° C. or higher, further preferably 550° C. or higher, and most preferably 560° C. or higher.

The glass for anti-dazzle processing of the present invention has low dependency on the concentration of the processing liquid when the main surface of the glass for anti-dazzle processing is subjected to anti-dazzle processing. This point can be confirmed by the fact that numerical values of slope 1 and slope 2 in Examples to be mentioned later are small. Since the dependency on the concentration of the processing liquid is low, it is not necessary to control the concentration of hydrofluoric acid (HF) and ammonium fluoride (NH₄F) in the processing liquid strictly. Therefore, the anti-dazzle processing is facilitated and the productivity of the anti-dazzle glass is improved.

Moreover, in the case of a soda lime silicate glass that is hitherto generally known, for enhancing precipitation ability of crystals, it is necessary to use a three-component processing liquid containing potassium fluoride (KF), for example, in addition to the above-described two components. However, in the glass for anti-dazzle processing of the present invention, it is possible to perform the anti-dazzle processing with a processing liquid containing only two components of hydrofluoric acid (HF) and ammonium fluoride (NH₄F). The anti-dazzle processing using these processing liquids is referred to as chemical anti-dazzle processing. In the present Description, the case of simple description as “anti-dazzle processing” means the chemical anti-dazzle processing.

Furthermore, to the processing liquid, if necessary, a fluoride ion source, a mineral acid or a buffer solution, or a combination thereof may be added.

The fluoride ion source is, for example, a salt selected from ammonium fluoride, ammonium hydrogen fluoride, sodium fluoride, sodium hydrogen fluoride, potassium fluoride, and potassium hydrogen fluoride, and similar salts and combinations thereof.

The mineral acid is, for example, hydrofluoric acid, sulfuric acid, hydrochloric acid, nitric acid, or phosphoric acid, a similar acid or a combination thereof. Moreover, there may be further added a glycol, glycerol, an alcohol, a ketone, or a surfactant, or a combination thereof.

Furthermore, if necessary, two or more steps of chemical anti-dazzle processing may be performed by using two or more kinds of different processing liquids. In addition, if necessary, before the chemical anti-dazzle processing is performed, physical anti-dazzle processing such as sand blasting may be performed.

Since the anti-dazzle performance is realized in any cases through a mechanism that glass is dissolved by immersing it in a processing liquid and dissolved glass components are precipitated as salts, it can be expected to obtain a similar effect as long as the glass of the present invention is used even when the processing liquid is changed.

In the case where the glass for anti-dazzle processing of the present invention is subjected to anti-dazzle processing, it is sufficient that at least one main surface of the glass for anti-dazzle processing of the present invention is immersed in a processing liquid containing hydrofluoric acid (HF) and ammonium fluoride (NH₄F) in predetermined concentration for a predetermined time.

Only one main surface of the glass for anti-dazzle processing of the present invention may be subjected to the anti-dazzle processing or both main surfaces thereof may be subjected to the anti-dazzle processing. In the present Description, a glass after being subjected to anti-dazzle processing is referred to as an “anti-dazzle glass”.

The concentration of hydrofluoric acid (HF) and the concentration of ammonium fluoride (NH₄F) in the processing liquid are appropriately selected depending on the required anti-dazzle processing. As indices of the anti-dazzle processing, a gloss value and a haze value measured for the main surface subjected to the anti-dazzle processing are used. The lower the measured gloss value is, more thoroughly the anti-dazzle processing has been performed. The higher the haze value that is an index of light diffusibility is, more thoroughly the anti-dazzle processing has been performed.

The temperature of the processing liquid is preferably 10 to 40° C. By controlling the temperature of the processing liquid to 10° C. or higher, the time required for the anti-dazzle processing is prevented from becoming long and the production efficiency of the anti-dazzle glass is improved. By controlling the temperature of the processing liquid to 40° C. or lower, the processing liquid is prevented from vaporizing and thus there are hardly generated problems on safety and environment. The temperature of the processing liquid is more preferably 15 to 35° C. and further preferably 20 to 30° C.

In the anti-dazzle glass of the present invention, it is preferred that the gloss value measured for the main surface subjected to the anti-dazzle processing is 10 to 90% and the haze value measured therefor is 4 to 70%, since the effect of the anti-dazzle processing is sufficiently exhibited and it is more preferred that the gloss value is 20 to 100% and the haze value is 5 to 60%.

Preferable gloss value and haze value are different depending on the kind of the anti-dazzle processing. In the case where the anti-dazzle processing is frost processing, it is preferred that the gloss value is low and the haze value is high. Specifically, it is preferred that the gloss value is 10 to 60% and the haze value is 10 to 60% and it is more preferred that the gloss value is 20 to 50% and the haze value is 20 to 50%.

In the case where the anti-dazzle processing is antiglare processing, it is preferred that the gloss value is relatively high and the haze value is relatively low. Specifically, it is preferred that the gloss value is 40 to 90% and the haze value is 5 to 40%, it is more preferred that the gloss value is 50 to 80% and the haze value is 7 to 20%, and it is further preferred that the gloss value is 70 to 80% and the haze value is 8 to 15%.

In a process for manufacturing the glass for anti-dazzle processing of the present invention, the composition of a glass substrate is controlled to the range specified in the present invention and, after forming into a sheet shape, surface processing of spraying a gas such as SO₂ onto at least one glass main surface is performed, and thereby the Na concentration on the surface can be lowered and the dependency on the concentration of the processing liquid for the anti-dazzle performance can be further decreased.

In the glass for anti-dazzle processing of the present invention, the Na concentration of at least one main surface thereof is preferably lowered. In the case where the Na concentration at the top surface (a depth of 0 to 5 nm) is lower than the average Na concentration for the depth of 100 to 150 nm, it can be said that the Na concentration of the surface is lowered. Therefore, in the glass for anti-dazzle processing of the present invention, it is preferred that, in Na concentration distribution in a sheet thickness direction in at least one main surface, the Na concentration at a depth of 0 to 5 nm is lower than the average Na concentration for the depth of 100 to 150 nm.

The Na concentration of the glass for anti-dazzle processing is measured by the method to be mentioned later in Examples by means of an X-ray photoelectron spectroscopic device. Moreover, the Na concentration distribution in a sheet thickness direction in at least one main surface means Na concentration distribution normalized by the average Na concentration for the depth of 100 to 150 nm.

In the Na concentration distribution in a sheet thickness direction of the glass for the anti-dazzle processing, the depth at which Na concentration reaches 90% or more of the average Na concentration for the depth of 100 to 150 nm is preferably 10 nm or more, more preferably 14 nm or more, and further preferably 18 nm or more. When the depth is 10 nm or more, the slopes of slope 1 and slope 2 to be mentioned later become gentle and the anti-dazzle performance becomes easily controllable.

In the Na concentration distribution in a sheet thickness direction of the glass for the anti-dazzle processing, the depth at which Na concentration reaches 90% or more of the average Na concentration for the depth of 100 to 150 nm of at least one main surface is preferably 60 nm or less, more preferably 50 nm or less, and further preferably 40 nm or less.

When the depth is 60 nm or less, excessive formation of mirabilite on the surface is suppressed and mirabilite attached on the surface can be easily removed by washing. Moreover, since the gas to be used for the surface processing, such as SO₂ or SO₃, is not excessively used, corrosion of facilities can be suppressed.

At least one main surface of the anti-dazzle glass of the present invention may be further subjected to chemical strengthening processing. In this case, the chemical strengthening processing is performed after the anti-dazzle processing is carried out. In the case where only one main surface has been subjected to the anti-dazzle processing, the chemical strengthening may be performed on the surface which has been subjected to the anti-dazzle processing or the chemical strengthening may be performed on the surface which has not been subjected to the anti-dazzle processing.

In the case where the chemical strengthening processing is performed on at least one main surface of the anti-dazzle glass of the present invention, at least one main surface of the anti-dazzle glass mentioned above is immersed in a nitrate molten salt at 400° C. to 465° C. for a predetermined time. As the nitrate molten salt, for example, potassium nitrate (KNO₃) is used. The time for the chemical strengthening processing is not particularly limited but, in a usual case, it is carried out for about 1 to 12 hours.

In order to obtain a higher surface compression stress (CS), it is preferred to use potassium nitrate having low concentration of impurities such as sodium nitrate. Specifically, the concentration of sodium nitrate in potassium nitrate is preferably 3% by mass or less and more preferably 1% by mass or less.

However, when the concentration of sodium nitrate is too low, a difference in CS among batches for chemical strengthening tends to occur, so that the concentration of sodium nitrate in potassium nitrate is preferably 0.05% by mass or more and more preferably 0.1% by mass or more.

In addition, since CS is lowered by stress relaxation when the time for the chemical strengthening processing is lengthened, the time for the chemical strengthening processing is preferably 8 hours or less and preferably 6 hours or less. When the time for the chemical strengthening processing is less than 1 hour, a depth of the surface compression stress layer (DOL) is small and there is a concern that a desired strength is hardly obtained. The time is preferably 1.5 hours or more and more preferably 2 hours or more. For the purpose of accelerating chemical strengthening and/or for the purpose of improving quality, an additive may be appropriately added into potassium nitrate.

The anti-dazzle glass of the present invention has satisfactory chemically strengthened properties in the case where at least one main surface thereof is subjected to the chemical strengthening processing. In the case where at least one main surface of the anti-dazzle glass of the present invention is subjected to the chemical strengthening processing, the depth of the surface compression stress layer (DOL) on the main surface subjected to the chemical strengthening processing is preferably 8 μm or more, for hardly influenced by scratches generated during processing, and DOL is more preferably 9 μm or more.

On the other hand, DOL on the main surface subjected to the chemical strengthening is preferably 25 μm or less for satisfactory cutting ability after the chemical strengthening, and is more preferably 20 μm or less and further preferably 18 μm or less.

DOL can be evaluated by a commercially available surface stress meter.

Moreover, the surface compression stress (CS) on the main surface subjected to the chemical strengthening processing is preferably 300 MPa or more, since breaking probability of the glass when it is dropped or bent decreases, and CS is more preferably 500 MPa or more, further preferably 600 MPa or more, and particularly preferably 700 MPa or more.

CS can be evaluated by a commercially available surface stress meter.

Moreover, in the case where use application of the anti-dazzle glass of the present invention is a cover glass for mobile devices, at least one main surface of the anti-dazzle glass is preferably subjected to chemical strengthening processing. In this case, it is preferred that DOL is 12 μm or more and CS is 550 MPa or more.

### EXAMPLES

The following will describe the present invention further in detail with reference to Examples but the present invention should not be construed as being limited thereto.

In each of Examples 1 to 8 and Comparative Examples 1 to 3 of Tables 1 and 2, glass raw materials were appropriately selected from ones generally used such as oxides, hydroxides, carbonates, and nitrates so as to have a composition specified by mass percentages in each column of from SiO₂ to ZrO₂, followed by weighing them so as to be the weight of 900 g as a glass. Subsequently, the mixed raw materials were put in a platinum crucible, followed by placing in a resistance heating electric furnace at 1,600° C. and melting for 4 hours, for defoaming and homogenizing.

The resulting molten glass was poured into a mold, maintained for 1 hour at a temperature of Tg+30° C., and then cooled to room temperature at a rate of 1° C./minute to obtain a glass block. The glass block was cut and ground and finally both surfaces thereof were processed into mirror surfaces to obtain a sheet glass (glass for anti-dazzle processing and glass for chemical strengthening) having a size of 30 mm×30 mm and a thickness of 1 mm. The glass transition point Tg, and the T₂ at which the glass viscosity reaches 10² dPa·s were measured by the following methods. The results are shown in Table 1.

### Glass Transition Point Tg: TMA Method

Temperature T₂: A glass sample is melted and the viscosity of the molten glass is measured by using a rotational viscometer. A temperature at which the viscosity reaches 10² dPa·s was taken as T₂ (° C.).

In Examples 8-1 to 8-3, the sheet glass was subjected to SO₂ processing in an electric furnace under any of the SO₂ processing conditions shown in Table 8 and then was taken out from the electric furnace and cooled to room temperature.

The amount of Na (atomic %) at a depth of 150 nm from the surface of the sheet glass was measured by an X-ray photoelectric spectroscopic device (manufactured by Ulvac-Phi, Incorporated., ESCA5500). The grinding of the sheet glass from the surface to 150 nm was effected by sputter-etching with a C60 ion beam.

Table 3 shows the results of Na concentration distribution normalized by the average Na concentration for the depth of 100 to 150 nm. Table 8 shows a depth at which Na concentration reaches 90% or more of the average Na concentration for the depth of 100 to 150 nm in the Na concentration distribution in a sheet thickness direction of the sheet glass.

For each of the sheet glass samples obtained by the above-described procedure, anti-dazzle processing was carried out by the following procedure.

### <Step 1 (Washing 1)>

After performing ultrasonic washing with ion-exchanged water for 5 minutes, the washing liquid was replaced with new ion-exchanged water and then ultrasonic washing was performed for 30 minutes. One surface was masked with an acid-resistant tape.

### <Step 2 (Washing 2)>

Washing with a 10% by mass aqueous hydrofluoric acid (HF) solution was performed for 15 seconds.

### <Step 3 (Chemical Anti-Dazzle Processing)>

The sample was immersed in each processing liquid (temperature: 30° C.) containing hydrofluoric acid (HF) and ammonium fluoride (NH₄F) in concentrations shown in Table 3 for 3 minutes. Of the 3 minutes, the processing liquid was stirred for first 30 seconds and was allowed to stand for remaining 2 minutes and 30 seconds.

<Step 4 (Washing with Water)>

After washing with tap water for 10 minutes, ultrasonic washing was performed for 5 minutes. The acid-resistant tape was peeled off.

For each of the glass samples after the anti-dazzle processing, a gloss value (Gloss) and a haze value (Haze) were measured by the following methods.

### <Gloss Value>

A gloss value of a surface that had not been masked with the acid-resistant tape, i.e., the surface subjected to the anti-dazzle processing was measured by using a gloss meter (IG-410) manufactured by Horiba Ltd.

### <Haze Value>

A haze value of the glass after the anti-dazzle processing was measured by using a haze computer (HZ-2) manufactured by Suga Test Instruments Co., Ltd.

The results are shown in Tables 4 to 7, 9, and 10. The gloss values (Gloss) shown in Tables 4, 5 and 9 and the haze values (Haze) shown in Tables 6, 7 and 10 are each an average value for 3 samples.

When a relationship between the HF concentration and the gloss value in the processing liquid is plotted, the gloss value becomes almost constant independent of the HF concentration under a condition that the HF concentration is low to some degree. Moreover, the gloss value becomes almost constant independent of the HF concentration under a condition that the HF concentration is high to some degree.

At evaluation of dependency on the concentration of the processing liquid in carrying out the anti-dazzle processing, it is necessary to eliminate a region where the gloss value becomes almost constant. Therefore, of the gloss values (Gloss) shown in Tables 4, 5 and 9, for each of ranges where the gloss value (Gloss) becomes 10 or more and then first reaches a numerical value exceeding 90 (ranges surrounded by bold lines in Tables 4, 5 and 9, hereinafter referred to as “slope-set ranges” in the present Description), an absolute value of slope of plots (slope 1) is determined. Also, for the haze values shown in Tables 6, 7 and 10, an absolute value of slope of plots (slope 2) is determined for each of the slope-set ranges (ranges surrounded by bold lines in Tables 6, 7 and 10) described above.

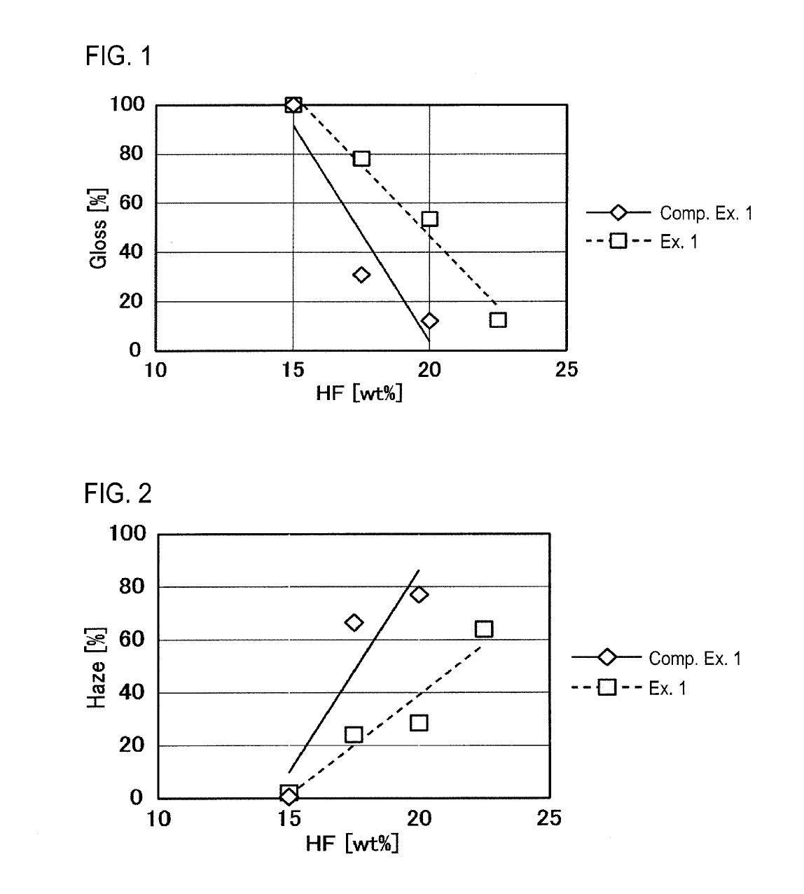

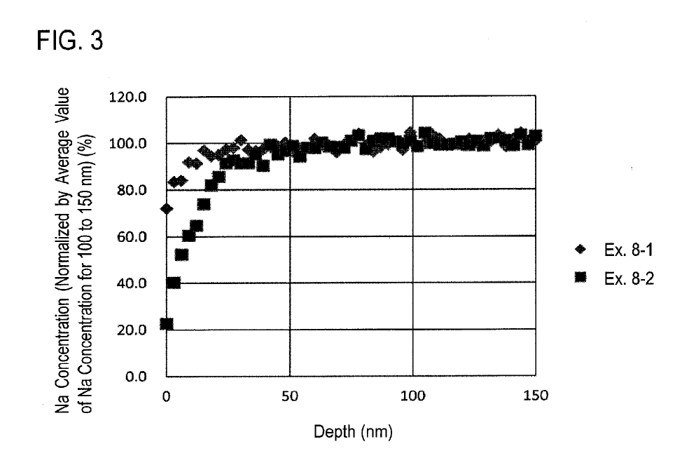

FIG. 1 is a graph showing a relationship between the HF concentration in the anti-dazzle processing liquid and the gloss value (%) of the glass after processing in Example 1 and Comparative Example 1, and an absolute value of slope of plots in FIG. 1 is the slope 1 described above.

FIG. 2 is a graph showing a relationship between the HF concentration in the anti-dazzle processing liquid and the haze value (%) of the glass after processing in Example 1 and Comparative Example 1, and an absolute value of slope of plots in FIG. 2 is the slope 2 described above.

In the present invention, these slope 1 and slope 2 are used as indices of the dependency on the concentration of the processing liquid in carrying out the anti-dazzle processing. The larger the numerical values of these slope 1 and slope 2 are, the larger the dependency on the concentration of the processing liquid in carrying out the anti-dazzle processing is. The smaller the numerical values of these slope 1 and slope 2 are, the smaller the dependency on the concentration of the processing liquid in carrying out the anti-dazzle processing is.

In FIG. 1 and FIG. 2, as compared with Comparative Example 1, Example 1 shows that slope 1 and slope 2 are small and thus the dependency on the concentration of the processing liquid in carrying out the anti-dazzle processing is small.

Moreover, for the sheet glass samples obtained in the above-described procedure, chemical strengthening processing was carried out by the following procedure.

### <Chemical Strengthening Processing>

The chemical strengthening processing was carried out by immersing a whole glass sample in a potassium nitrate molten salt at 425° C. for 150 minutes. The concentration of sodium nitrate in the potassium nitrate molten salt was controlled to 2.2%.

The depth of the surface compression stress layer (DOL) of the glass sample after chemical strengthening processing and the surface compression stress (CS) were measured by using a surface stress meter (manufactured by Orihara Industrial Co., Ltd.: FSM-6000).

TABLE 1

| wt % | Example 1 | Example 2 | Example 3 | Example 4 | Example 5 |
|---|---|---|---|---|---|
| SiO₂ | 68.3 | 68.3 | 68.0 | 67.37 | 67.8 |
| Al₂O₃ | 5.0 | 5.0 | 5.9 | 7.17 | 8.0 |
| Na₂O | 15.0 | 15.0 | 16.1 | 16.79 | 14.7 |
| K₂O | 0.1 | 0.1 | 0.0 | 0.0 | 0.0 |
| MgO | 4.1 | 4.1 | 9.0 | 4.07 | 9.0 |
| CaO | 7.0 | 7.0 | 1.0 | 4.60 | 0.5 |
| ZrO₂ | 0.0 | 0.0 | 0.0 | 0.0 | 0.0 |
| Tg (° C.) | 556 | 556 | 574 | 553 | 605 |
| CS (MPa) | 634 | 634 | 761 | 674 | 767 |
| DOL (μm) | 9 | 9 | 15 | 14 | 15 |
| T₂ (° C.) | 1455 | 1455 | 1492 | 1485 | 1548 |

TABLE 2

| | | | | Comparative | Comparative | Comparative |
|---|---|---|---|---|---|---|
| wt % | Example 6 | Example 7 | Example 8 | Example 1 | Example 2 | Example 3 |
| SiO₂ | 64.5 | 67.0 | 67.8 | 71.8 | 66.1 | 64.3 |
| Al₂O₃ | 9.8 | 7.2 | 5.9 | 1.9 | 6.3 | 7.8 |
| Na₂O | 17.5 | 15.8 | 16.1 | 13.3 | 12.3 | 15.8 |
| K₂O | 0.0 | 1.0 | 0.2 | 0.3 | 3.5 | 2.0 |
| MgO | 4.5 | 4.1 | 9.0 | 4.6 | 3.9 | 5.5 |
| CaO | 3.6 | 4.9 | 1.0 | 7.8 | 7.8 | 2.6 |
| ZrO₂ | 0.0 | 0.0 | 0.0 | 0.0 | 0.0 | 2.0 |
| Tg (° C.) | 563 | 554 | 571 | 557 | 565 | 563 |
| CS (MPa) | 745 | 684 | 743 | 542 | 618 | 771 |
| DOL (μm) | 16 | 14 | 15 | 6 | 12 | 18 |
| T₂ (° C.) | 1499 | 1488 | 1484 | 1447 | 1464 | 1496 |

TABLE 3
wt %

| | | | | | | | | | | |
|---|---|---|---|---|---|---|---|---|---|---|
| HF | 25 | 22.5 | 20 | 17.5 | 15 | 12.5 | 10 | 7.5 | 5 | 2.5 |
| H₂O | 45 | 47.5 | 50 | 52.5 | 55 | 57.5 | 60 | 63 | 65 | 67.5 |
| NH₄F | 30 | 30 | 30 | 30 | 30 | 30 | 30 | 30 | 30 | 30 |

TABLE 4

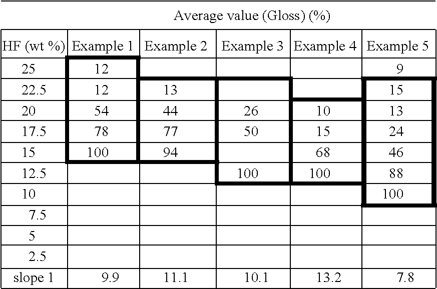

TABLE 5

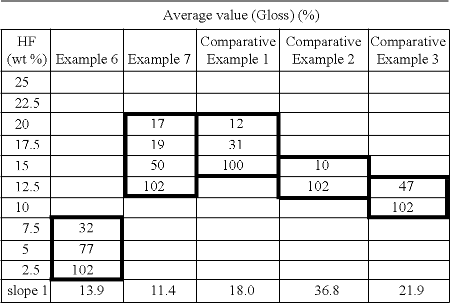

TABLE 6

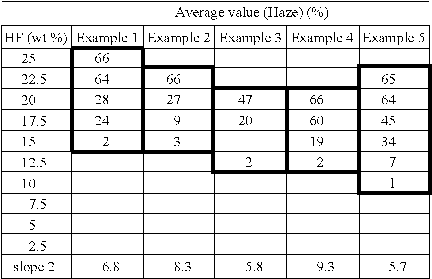

TABLE 7

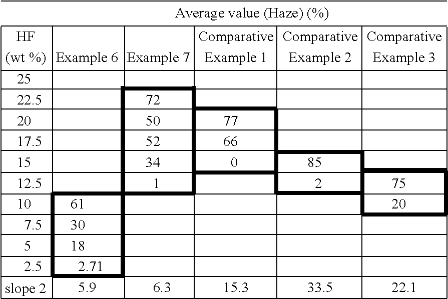

TABLE 8

| | | | Example |
|---|---|---|---|
| | Example 8-1 | Example 8-2 | 8-3 |
| SO₂ processing time (second) | 0 | 30 | 120 |
| Processing temperature (° C.) | 625 | 625 | 625 |
| SO₂ gas (L/minute) | 0.2 | 0.2 | 0.2 |
| Air (L/minute) | 1.4 | 1.4 | 1.4 |
| Depth at which concentration | 9 | 24 | 33 |
| reaches 90% or more of average | | | |
| concentration for 100-150 nm in | | | |
| Na concentration distribution | | | |

TABLE 9

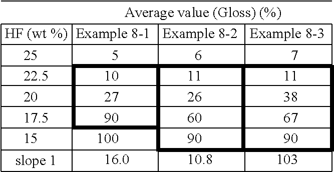

TABLE 10

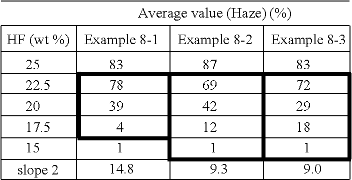

As is apparent from Tables 4 to 7, it was found that all of the glass samples of Examples have small numerical values of slope 1 and slope 2 as compared with the glass samples of Comparative Examples and thus the dependency on the concentration of the processing liquid in carrying out the anti-dazzle processing is small.

Moreover, in the glass samples of Examples, DOL was as high as 8 μm or more, CS was as high as 300 MPa or more, chemical strengthening properties were satisfactory, Tg was also as high as 520° C. or higher, and the temperature T₂ at which the viscosity reached 10² dPa·s was 1,600° C. or lower.

As is apparent from Tables 8 to 10, in the case where the depth at which, in the Na concentration distribution in a sheet thickness direction of the glass sample, the concentration reaches 90% or more of the average Na concentration for the depth of 100 to 150 nm is 10 nm or more, it was found that the slopes of slope 1 and slope 2 become gentle and thus the dependency on the concentration of the processing liquid in carrying out the anti-dazzle processing becomes small.

While the present invention has been described in detail and with reference to specific embodiments thereof, it will be apparent to one skilled in the art that various changes and modifications can be made therein without departing from the spirit and scope of the present invention. The present application is based on a Japanese patent application filed on Jul. 18, 2014 (Application No. 2014-148033), the whole thereof being incorporated herein by reference. In addition, all references cited herein are incorporated as a whole.

1. A glass for anti-dazzle processing, comprising, as expressed by mass percentage on the basis of oxides:
60 to 75% of SiO₂,
2.5 to 10% of Al₂O₃,
13 to 19% of Na₂O,
0 to 1.8% of K₂O,
0 to 12% of MgO,
0 to 9% of CaO, and
0 to 4% of ZrO₂.

2. The glass for anti-dazzle processing according to claim 1, further comprising Fe₂O₃ and comprising, as expressed by mass percentage on the basis of oxides:
64 to 71% of SiO₂,
2.5 to 10% of Al₂O₃,
13 to 18% of Na₂O,
0 to 1.8% of K₂O,
6 to 12% of MgO,
0.5 to 9% of CaO,
0 to 3% of ZrO₂, and
0 to 0.05% of Fe₂O₃.

3. The glass for anti-dazzle processing according to claim 1, wherein, in an Na concentration distribution in a sheet thickness direction in at least one main surface of the glass for anti-dazzle processing, an Na concentration at a depth of 0 to 5 nm is lower than an average Na concentration for a depth of 100 to 150 nm, and a depth at which an Na concentration reaches 90% or more of the average Na concentration for the depth of 100 to 150 nm is 10 nm or more.

4. An anti-dazzle glass, wherein at least one main surface of the glass for anti-dazzle processing according to claim 1 has been subjected to an anti-dazzle processing.

5. The anti-dazzle glass according to claim 4, wherein the anti-dazzle processing is a frost processing.

6. The anti-dazzle glass according to claim 4, wherein the anti-dazzle processing is an antiglare processing.

7. The anti-dazzle glass according to claim 4, wherein a gloss value is 10 to 90% and a haze value is 4 to 70%, both values being measured for the main surface which has been subjected to the anti-dazzle processing.

8. The anti-dazzle glass according to claim 4, wherein at least one main surface thereof has been subjected to a chemical strengthening processing.

9. The anti-dazzle glass according to claim 4, wherein the anti-dazzle processing is a chemical anti-dazzle processing.
